(19) United States
(12) Patent Application Publication
(10) Pub. No.: US 2026/0309331 A1
(43) Pub. Date: Oct. 8, 2026

(54) OVEN DOOR

(71) Applicant: OONI LIMITED, Broxburn, West Lothian (GB)

(72) Inventors: Iain MORTIMER, Broxburn, West Lothian (GB); Thomas MCKEE, Broxburn, West Lothian (GB)

(21) Appl. No.: 19/481,447

(22) PCT Filed: May 3, 2024
(86) PCT No.: PCT/GB2024/051176

§ 371 Date: Nov. 4, 2025

(30) Foreign Application Priority Data
May 5, 2023 (GB) 2306709.3

(51) Int. Cl. F24B 13/00; A47J 37/06; F24B 5/02; F24C 15/04

(52) U.S. Cl. CPC F24B 13/004; A47J 37/0658; A47J 37/0664; F24B 5/023; F24C 15/04

(57) ABSTRACT

In summary, there is provided a door (100) for an oven, the door comprising: a viewing window (110) having an outer perimeter (111), a viewing window outer face (110A) and a viewing window inner face (110B); and a frame (120) surrounding the viewing window (110), wherein the viewing window (110) is secured in the frame (120) by at least one attachment point (140), wherein at least one gap (150) is defined between the outer perimeter (111) of the viewing window (110) and the frame (120), whereby an air flow path is provided through the at least one gap (150) and across at least a portion of the viewing window inner face (110B).

### FIELD OF THE INVENTION

The present invention relates to doors for ovens.

### BACKGROUND TO THE INVENTION

Ovens for cooking food items typically comprise an oven chamber into which food items are inserted and a heat source which provides heat to the oven chamber to cook the food items. Many ovens have doors which seal the oven chamber to avoid heat loss occurrence from the oven chamber.

Often, the doors become dirty owing to soot deposit which is formed on the inner face of the door through burning of fuel sources such as wood or charcoal. To remove the soot deposit from the door a lot of cleaning is required which is inconvenient for the user. Moreover, the sooting can adversely affect the flavour of the food items during cooking resulting in an overly charred flavour. The soot deposit on the door has a particularly negative effect if the door comprises a viewing window as these viewing windows are intended to remain clear (and thus free of soot) to allow the user to view the items during cooking.

Some ovens comprise vents in the oven body which allow for air to travel through the oven; however, these isolated vents only allow for directed air flow along isolated paths in the oven body or across the door. Vents that are close to the door provide isolated directed air flow paths that are largely offset from the face of door and any viewing window thereon.

It is in this context that the present inventions have been devised.

### SUMMARY OF THE INVENTION

In accordance with an aspect of the present invention, there is provided a door for an oven, the door comprising: a viewing window having an outer perimeter, a viewing window outer face and a viewing window inner face; and a frame surrounding the viewing window, wherein the viewing window is secured in the frame by at least one attachment point, wherein at least one gap is defined between the outer perimeter of the viewing window and the frame, whereby an air flow path is provided through the at least one gap and across at least a portion of the viewing window inner face.

The door may be for a pizza oven. The pizza oven may be a portable pizza oven. The pizza oven may be a fuel burning oven. The pizza oven may be a portable fuel burning pizza oven. When the door is attached to an oven such as a pizza oven in use, the configuration of the gap between the frame and the outer perimeter of the viewing window in the door provides the air flow path that allows for air external to the oven to travel through the gap and directly across the viewing window. The air flow path thus provides a route for air to travel from a region external to the door and through the gap, resulting in air passing over the inner face of the viewing window. Accordingly, the air can flow over the inner face of the viewing window and this reduces soot deposit on the inner face of the oven, typically allowing the viewing window to be substantially free of soot. This allows for a superior air flow within the oven directed at soot reduction on the door compared to typical ovens on the market which have vents in the oven body and thus only allow for isolated directed air flow paths which are often far removed from reaching the face of the door itself. The air may flow through an inner periphery of the frame, on the outside of the viewing window, around an outer periphery of the viewing window and through the inner periphery of the frame on the inside of the viewing window.

The frame surrounds the viewing window such that the viewing window is in the frame. Attachment of the viewing window to the frame by at least one attachment point secures the viewing window to the frame at the same time as providing the gap to allow the air flow through the frame and past the outer face of the viewing window. The attachment point may be at any location on the frame and there may be any number of attachment points greater than or equal to one. This provides a large degree of customisability.

The frame may have an inner and an outer perimeter. The inner perimeter of the frame may define an aperture which exposes the viewing window. The outer perimeter of the l viewing window may be between the inner and outer perimeter of the frame. In this configuration, the viewing window may extend beyond the aperture defined by the inner perimeter of the frame and into the frame. The gap can extend along substantially the whole outer perimeter of the viewing window. In this way a free passage of air is allowed between the outer and inner face of the viewing window through the air flow path it provides.

The viewing window may be secured to the frame at a plurality of attachment points, thereby forming a plurality of gaps around the viewing window. The gap may therefore be divided into further gaps by the at least one attachment point.

Each of the one or more gaps can act as channels. In this way, a flow of air can be directed through each of the gaps, through the channel and across the inner face of the viewing window for enhanced soot reduction.

The at least one attachment point can act as a partial barrier or baffle to the air flowing into the door from outside of the oven. There may be two, three, four or more attachment points that secure the viewing window to the frame. There may be an attachment point at each of the four corners of the viewing window. Each attachment point may divide the gap into a corresponding number of gaps. For example, there may be four attachment points and these may divide the gap into four gaps along the outer perimeter of the viewing window. The attachment points may be located anywhere on the frame to secure the viewing window to the frame. For example, the attachment points may be located on an upper portion of the frame, on a lower portion of the frame, on a side portion of the frame or on any combination of points along the frame. For example, there may be two attachment points on an upper portion of the frame and two attachment points on a lower portion of the frame. The gaps may be slots. The at least one attachment point may comprise a clamp. Other configurations of the attachment point may include a supporting hook, a clip, a fastener or any other securing means to attach the viewing window to the frame.

The frame may have an interior cavity and an exterior. The interior cavity may comprise insulation. A gap may be formed between the insulation and the outer perimeter of the viewing window. The interior cavity may be formed by a lip on the frame that extends all the way along a periphery of the frame. The insulation may comprise at least one of the materials selected from the following: ceramic fibre, fiberglass, mineral fibre, mineral wool, polyurethane, and silicone. The insulation in the interior cavity reduces the temperature of the exterior of the frame and makes it safe for a user to touch.

The door may comprise a gap defining member within the interior cavity that defines the gap formed between the interior cavity and the outer perimeter of the viewing window. The gap defining member may comprise at least one protrusion. In this way, the at least one protrusion can act as a support for the insulation within the cavity. The gap defining member may comprise at least one ledge. The gap defining member may comprise a bracket. The gap defining member may be positioned on an upper portion of the interior cavity, on a lower portion of the interior cavity, or on a side of the interior cavity.

The gap defined between the interior cavity and the viewing window perimeter may have a breadth, typically between the gap defining member and the outer perimeter of the viewing window of at least 1.5 mm. For example, the breadth may be between 1.5 to 6.0 mm. The larger the gap within the range, the more air that can flow through the gap and over the inner surface of the viewing window. The smaller the gap within the range, the more insulation that can be incorporated into the interior cavity to reduce the temperature of the frame exterior and the less cold air that is drawn in from the outside of the oven.

The door may comprise an outer face with a handle thereon. The outer face may be the frame exterior or another component part separate to the frame. The handle may be any shape or size to enable a user to open the door so as to expose the oven chamber when the door is attached to an oven. The handle may be attached to the frame above the viewing window. The handle may be attached to the frame beneath the viewing window. The handle may be attached to the frame at a side of the viewing window.

It may be that the insulation is located in the frame behind the handle. In other words, the insulation may be directly opposite the handle in the interior cavity. In this way the insulation provided in the interior cavity will protect the handle from becoming too hot, thus protecting the user when they come to open or close the oven chamber using the door when attached to the oven body.

It may be that, when the door comprises a gap defining member, at least part of the insulation is separated from the outer perimeter of the viewing window by the gap defining member. The at least part of the insulation may be in contact with the gap defining member. For example, it may rest on the gap defining member. It may be that, when the door comprises a gap defining member above the viewing window, at least part of the insulation is provided thereon such that at least part of the insulation is located above the gap formed between the insulation and the outer perimeter of the viewing window, above the viewing window. In this way, the at least part of the insulation is separated from the gap formed between the insulation and the outer perimeter of the viewing window and allows a clear path for air flow to pass through the frame and across the inner face of the viewing window to contribute to the soot reduction.

The door may further comprise an air flow guide adjacent the viewing window inner surface, at the periphery of the viewing window, wherein the air flow guide is in fluid communication with the one or more gaps and the viewing window inner surface, to thereby guide air onto the viewing window inner surface. The air flow guide may comprise an angled portion configured to guide air directly onto the viewing window inner surface. The angled portion is typically angled such that the angled portion extends in a direction towards the viewing window inner surface as it extends further from the periphery of the viewing window. The air flow guide may comprise a cavity.

The cavity may be at least partially defined by the angled portion. The angled portion may be angled such that, in use, air flowing through the at least one gap enters the cavity and exits the cavity at a region located between the angled portion and the viewing window inner surface. By providing an air flow guide in this way, more air is directed onto the inner surface of the viewing window to further promote reduction in soot deposits forming on the viewing window surface.

The air flow guide may be formed by a component depending from a top surface of the interior cavity or from a back wall of the interior cavity. The component may comprise an elongate part extending from the top surface or back wall of the interior cavity to a part distal to the top surface of the interior cavity that is angled so as to direct air flow against the inner face of the viewing window. The part distal to the top surface may comprise a degree of curvature.

In a further aspect of the invention, there is provided an oven comprising an oven chamber having an opening and a door according to any embodiment of the preceding aspect, pivotably mounted thereto. The door may be detachably attached to the oven. The door may be attached to the oven such that it can move between a closed position where it closes the opening and an open position where the opening is exposed. The door therefore allows for a large amount of heat retention in the oven chamber when closed, at the same time as providing a pathway for air to enter the oven through the at least one gap and flow over the inner face of the viewing window. In this way a highly efficient oven with high heat retention highly reduced sooting is provided.

The oven may be a pizza oven. The pizza oven may be a portable pizza oven. The pizza oven may be a fuel burning oven. The pizza oven may be a portable fuel burning pizza oven.

The oven may comprise a flue. Typically, the flue extends from the roof of the oven chamber to the exterior of the oven. The flue provides a path for heated air to leave the oven chamber. Accordingly, air is drawn into the oven chamber through the one or more gaps.

In a further aspect of the invention, there is provided a method comprising the steps of: providing an oven according to the previous aspect; providing a fuel to the oven; and burning the fuel with the door closed. Air may thereby be drawn into the oven chamber through the at least one gap.

Typically, air which passes into the oven chamber through the one or more gaps mixes with combusted gas in the oven. Typically, the air which passes into the oven chamber through the one or more gaps is not used for combustion. Typically, the oven comprises a (separate) air supply for combustion of fuel. Typically this (separate) air supply is located at the rear of the oven, opposite to the door.

By the terms ‘inner’ and ‘outer’ we refer to positions or surfaces of a door when the door is attached to an oven. Accordingly, inner will be understood to mean closest to the inside of the oven and outer will be understood to mean away from the inside of the oven and therefore facing away from the inside of the oven. Typically, the door comprises a handle and the surface with the handle is the outer surface. It will also be understood that the term ‘periphery’ means the outer edge of a component part.

### DESCRIPTION OF THE DRAWINGS

An example embodiment of the present invention will now be illustrated with reference to the following Figures in which:

FIG. 1 is a perspective view of a door according to an example of the present disclosure;

FIG. 2 is a cross-sectional side view of the door according to an example of the present disclosure.

FIGS. 3A and 3B are, respectively, a view from the back of the door and a cross-sectional view from the back of the door according to an example of the present disclosure.

FIG. 4 is a cross-sectional side view of the door attached to an oven according to an example of the present disclosure.

### DETAILED DESCRIPTION OF AN EXAMPLE EMBODIMENT

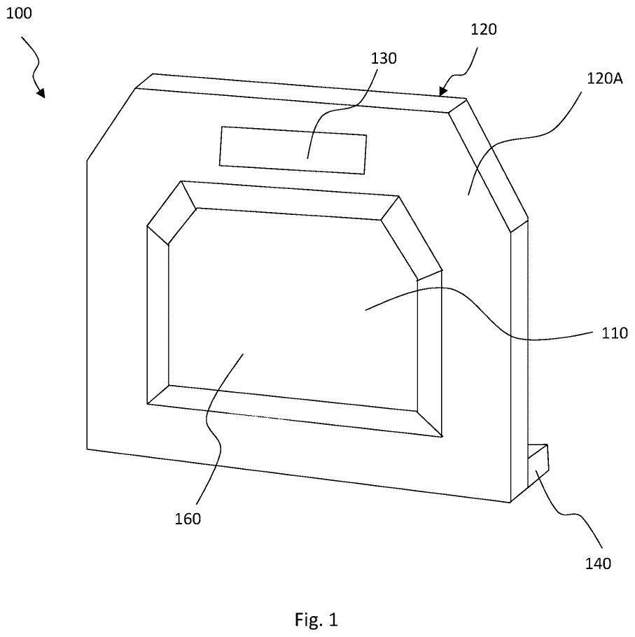

In accordance with an embodiment of the invention, as shown by FIG. 1, there is provided an oven door 100 which has a viewing window 110 and a frame 120 around the viewing window. The frame has an exterior 120A as shown in FIG. 1 and an interior cavity (not shown). An aperture 160 is defined through the frame. The viewing window occludes the aperture. In use the user can look through the viewing window to see into an oven. The viewing window has an outer face 110A which, when the door is connected to an oven that comprises an oven chamber, faces away from the oven chamber. An inner face of the viewing window (not shown) is on the opposing side of the viewing window to the outer face. The door also has a handle 130 on a top portion of the frame. The viewing window is secured to the frame at an attachment point on the corner of the viewing window by clamp 140. Other attachment points are not shown in this view but are located at the other three corners of the viewing window. The viewing window and the frame move together when the door is opened and closed.

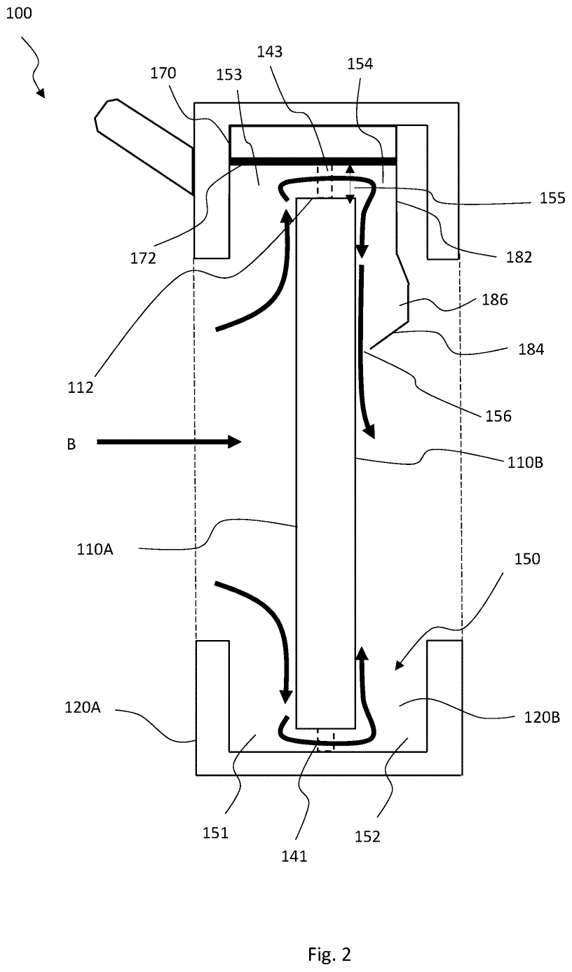

FIG. 2 shows a cross-sectional side view of the door 100 with the frame 120. The viewing window extends into an interior cavity 120B of the frame such that the viewing window extends beyond the aperture defined by the frame. The frame surrounds the viewing window and clamp 141 and support 143 which act as further attachment points are shown.

There is a gap 150 formed between the viewing window and the frame and the attachment points divide this gap into four further gaps 151, 152, 153, 154. The inner face 110B of the viewing window is shown on the opposite side of the viewing window to the outer face 110A. The gaps act as channels through which air from outside of the oven can pass through, travelling around the viewing window and then across the inner face of the viewing window to prevent soot from depositing thereon. The gaps therefore define an air flow path that provides a route for air to travel from a region external to the door and through the gap, resulting in air passing over the inner face of the viewing window.

The interior cavity of the frame 120B has a component comprising a channel defining support 182 that depends from a top surface of the interior cavity and extends to an air guide 184 distal to the top surface of the frame that is angled so as to direct downward air flow against the inner face of the viewing window. The shape of the component forms a cavity 186 which aids in directing air flowing around the viewing window across the inner face of the viewing window, thus further aiding soot reduction.

The bold arrows show the flow of air B from outside of the oven from the outer face of the viewing window, travelling through the gaps, around the viewing window and then travelling across the inner face of the viewing window (and thus along the air flow path that is provided), providing a blanket of air as a soot prevention layer on the inner face of the viewing window. In some embodiments, air also travels around the sides of the glass.

The interior cavity comprises insulation 170 as shown that is provided on a gap defining member configured as a ledge 172 within the interior cavity. A gap 155 is defined between the ledge 172 and the outer perimeter of the viewing window, and a breadth of the gap 155 is defined between a top portion 112 of the outer perimeter of the viewing window and the ledge 172 as shown by the double ended arrow in FIG. 2. The gap breadth is at least 1.5 mm.

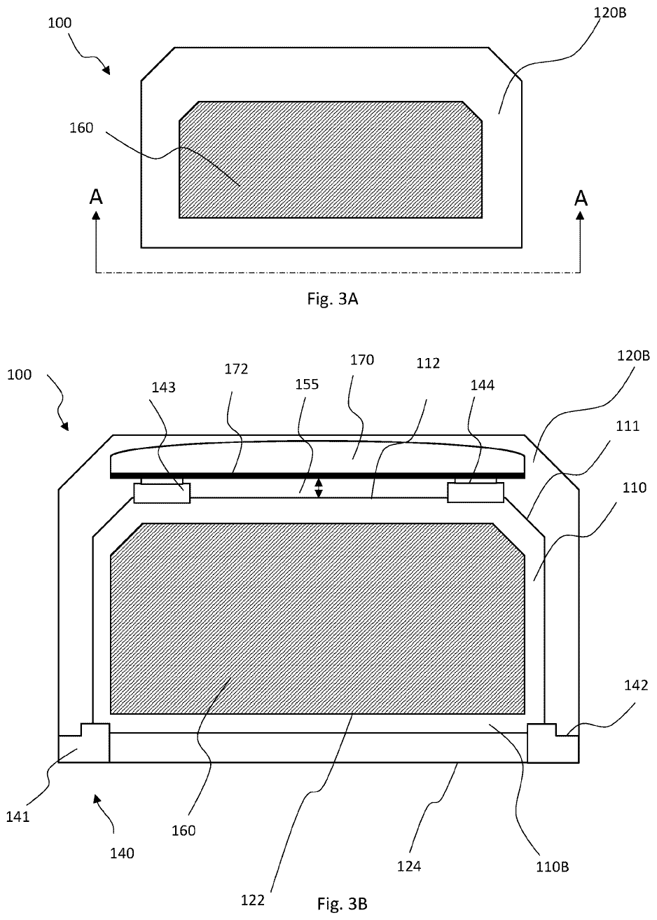

FIG. 3A is a view from the back of the door 100. FIG. 3B is a cross-sectional view from the back of the door along cutting plane A-A in FIG. 3A. As shown in FIG. 3B, the viewing window has an outer perimeter 111 which is surrounded by the frame 120. The frame comprises an inner perimeter 122 and an outer perimeter 124 and the interior cavity of the frame 120B is exposed in this cross-sectional view. The viewing window is secured to the frame by attachment clamps 141, 142 located on a lower part of the frame and supporting clips 143, 144 located on an upper part of the frame. The interior cavity comprises insulation 170 as shown in FIG. 3B that is provided on a gap defining member configured as a ledge 172 within the interior cavity. A gap 155 is defined between the ledge 172 and the outer perimeter of the viewing window, and a breadth of the gap 155 is defined between a top portion 112 of the outer perimeter of the viewing window and the ledge 172 as shown by the double ended arrow in FIG. 3B. The gap breadth is at least 1.5 mm.

The door further comprises an outer face opposite to the frame interior with a handle thereon (not shown). The insulation 170 and the gap 155 are located in the frame interior and behind the handle. In this way, when the door is attached onto an oven in use, heat generated from the oven chamber will reach the door interior cavity and the insulating material will absorb a substantial amount of the heat so that the handle on the door outer surface remains cool to the touch and suitable for safe use. The gap 155 acts as a channel for which air from outside of the oven can flow into the oven through the gap in the door and onto the inner surface of the viewing window.

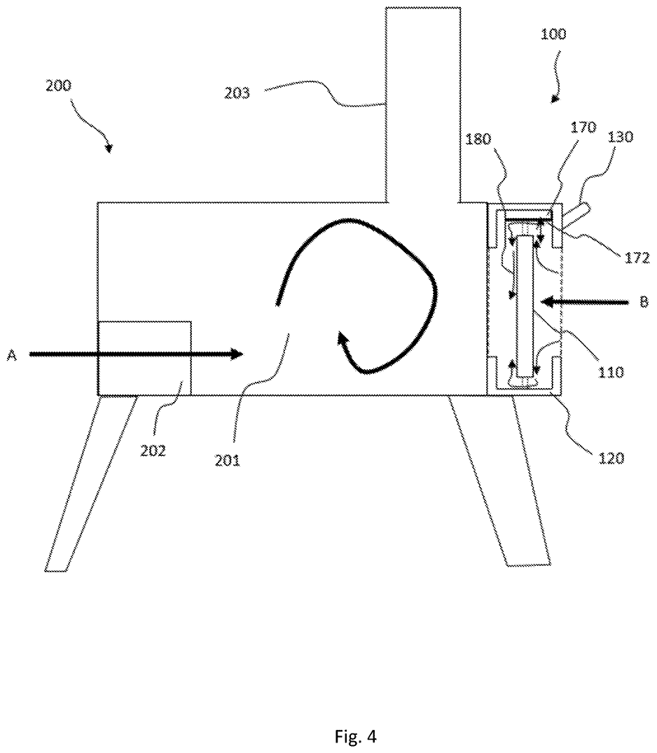

When incorporated into an oven, the door provides a means to open and close an oven chamber within the oven. As shown in FIG. 4, the door 100 is attached onto a front of an oven 200. The oven has an oven chamber 201 in which a heat source 202 is located at the rear of the oven to heat the oven chamber. The oven also has a flue 203 which allows for the escape of hot air and smoke produced in the oven chamber. In use, the door is attached onto the oven, fuel is provided to the oven and this fuel is burnt to heat the oven chamber.

The heat source can, for example, be a solid fuel burner using wood or charcoal as fuel. The heat source draws in air, A, from outside the oven that is combusted with the fuel. The combustion produces a flame that is provided within the oven chamber. The air that has been combusted with the fuel is combusted air that circulates in the oven chamber and soot is produced as a by product of burning the fuel. Air external to the oven that is colder than the temperature of the inside of the oven chamber, B, is drawn into the oven chamber through the gap that is arranged between the inner perimeter of the frame and the outer face of the viewing window of the door. As this air travels across the inner face of the viewing window, there is a reduction in the soot which can deposit on the inner face of the viewing window compared to when the gap is no present. Accordingly, the gap provides for a reduction of soot on the viewing window inner face when the door is connected to an oven body in use. The air A travels along the air flow path as shown by the bold arrows. The separate air supplies at the rear and front of the oven, A, B, may mix and escape the oven through flue 203. Air supply B is the predominant air supply which travels through the door and across the inner face of the viewing window to produce effective soot deposit prevention on the inner surface.

Throughout the description and claims of this specification, the words “comprise” and “contain” and variations of them mean “including but not limited to”, and they are not intended to and do not exclude other components, integers, or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, or groups described in conjunction with a particular aspect, embodiment, or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A door for an oven, the door comprising: a viewing window having an outer perimeter, a viewing window outer face and a viewing window inner face; and a frame surrounding the viewing window, wherein the viewing window is secured in the frame by at least one attachment point, wherein at least one gap is defined between the outer perimeter of the viewing window and the frame, whereby an air flow path is provided through the at least one gap and across at least a portion of the viewing window inner face.

2. The door according to claim 1, wherein the frame has an inner and an outer perimeter and the outer perimeter of the viewing window is between the inner and outer perimeter of the frame.

3. The door according to claim 1, wherein the viewing window is secured to the frame at a plurality of attachment points, thereby forming a plurality of gaps around the viewing window.

4. The door according to claim 1, wherein the one or more gaps are channels.

5. The door according to claim wherein the at least one attachment point comprises a clamp.

6. The door according to claim 1, wherein the frame has an interior cavity and an exterior, the cavity comprising insulation, a gap located between the insulation-and the outer perimeter of the viewing window.

7. The door according to claim 6, comprising a gap defining member within the cavity to define the gap.

8. The door according to claim 7, wherein the gap defining member comprises at least one protrusion.

9. The door according to claim 7, wherein the gap defining member comprises at least one ledge.

10. The door according to claim 7, wherein the gap has a breadth, between the gap defining member and the outer perimeter of the viewing window, of at least 1.5 mm.

11. The door according to claim 1, wherein the door has an outer face with a handle thereon.

12. The door according to claim 11, wherein the handle is attached to the frame, above the viewing window.

13. The door according to claim 11, wherein the frame has an interior cavity and an exterior, the cavity comprising insulation, a gap located between the insulation and the outer perimeter of the viewing window, and wherein the cavity comprises insulation in the frame, behind the handle.

14. The door according to claim 13, wherein, when the door comprises a said gap defining member above the viewing window, at least part of the insulation is provided thereon, such that the gap defining member above the viewing window keeps the insulation spaced apart from the outer perimeter of the viewing window, above the viewing window.

15. The door according to claim 1, comprising an air flow guide adjacent the viewing window inner surface, at the periphery of the viewing window, wherein the air flow guide is in fluid communication with the one or more gaps and the viewing window inner surface, to thereby guide air onto the viewing window inner surface.

16. The door according to claim 15, wherein the air flow guide comprises an angled portion configured to guide air directly onto the viewing window inner surface.

17. The door according to claim 15, wherein the air flow guide comprises a cavity.

18. An oven comprising an oven chamber having an opening and a door according to claim 1, pivotably mounted thereto.

19. A method of preventing soot deposit on an oven door, the method comprising the steps of: providing an oven according to claim 18; providing a fuel to the oven; and burning the fuel with the door closed, thereby drawing air into the oven chamber through the at least one gap.
